(19) United States
(12) Patent Application Publication
(10) Pub. No.: US 2023/0134354 A1
(43) Pub. Date: May 4, 2023

(54) DATABASE INTEGRATION OPERATIONS USING ATTENTION-BASED ENCODER-DECODER MACHINE LEARNING MODELS

(71) Applicant: Optum, Inc., Minnetonka, MN (US)

(72) Inventors: Swapna Sourav Rout, Bangalore (IN); Sudeep Choudhary, Jharia (IN); Ankit Varshney, Delhi (IN)

(21) Appl. No.: 17/453,259

(22) Filed: Nov. 2, 2021

(51) Int. Cl. G06N 3/08; G06N 3/04; G06F 16/25

(52) U.S. Cl. CPC G06N 3/08; G06N 3/0445; G06N 3/0427; G06F 16/25

(57) ABSTRACT

Various embodiments of the present invention provide methods, apparatus, systems, computing devices, computing entities, and/or the like for database integration. For example, certain embodiments of the present invention utilize systems, methods, and computer program products that perform database integration by utilizing attention-based encoder-decoder machine learning models, such as by performing cross-row linking/similarity determination operations based at least in part on row-wise representations that are generated by combining column-wise representations that are generated by an encoder sub-model of an attention-based encoder-decoder machine learning model, and/or by performing cross-column linking/similarity determination operations based at least in part on column-wise representations that are generated based at least in part on attention scores generated by vertical self-attention sub-models of an attention-based encoder-decoder machine learning model.

### BACKGROUND

Various embodiments of the present invention address technical challenges related to performing database integration operations and address the efficiency and reliability shortcomings of existing database integration solutions.

### BRIEF SUMMARY

In general, embodiments of the present invention provide methods, apparatus, systems, computing devices, computing entities, and/or the like for database integration. For example, certain embodiments of the present invention utilize systems, methods, and computer program products that perform database integration by utilizing attention-based encoder-decoder machine learning models, such as by performing cross-row linking/similarity determination operations based at least in part on row-wise representations that are generated by combining column-wise representations that are generated by an encoder sub-model of an attention-based encoder-decoder machine learning model, and/or by performing cross-column linking/similarity determination operations based at least in part on column-wise representations that are generated based at least in part on attention scores generated by vertical self-attention sub-models of an attention-based encoder-decoder machine learning model.

In accordance with one aspect, a method is provided. In one embodiment, the method comprises: for each column value, generating a column-wise representation using an encoder sub-model of an attention-based encoder-decoder machine learning model, wherein: (a) the attention-based encoder-decoder machine learning model comprises the encoder sub-model, a plurality of vertical self-attention sub-models, and a plurality of decoder sub-models, (b) during a training iteration, the attention-based encoder-decoder machine learning model is updated based at least in part on an inferred column value for each training column value of a plurality of training column values of a training table row, (c) the plurality of training column values comprise a masked training column value of the training table row, and (d) during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model; generating the row-wise representation based at least in part on each column-wise representation; and performing one or more prediction-based actions based at least in part on the row-wise representation.

In accordance with another aspect, a computer program product is provided. The computer program product may comprise at least one computer-readable storage medium having computer-readable program code portions stored therein, the computer-readable program code portions comprising executable portions configured to: for each column value, generate a column-wise representation using an encoder sub-model of an attention-based encoder-decoder machine learning model, wherein: (a) the attention-based encoder-decoder machine learning model comprises the encoder sub-model, a plurality of vertical self-attention sub-models, and a plurality of decoder sub-models, (b) during a training iteration, the attention-based encoder-decoder machine learning model is updated based at least in part on an inferred column value for each training column value of a plurality of training column values of a training table row, (c) the plurality of training column values comprise a masked training column value of the training table row, and (d) during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model; generate the row-wise representation based at least in part on each column-wise representation; and perform one or more prediction-based actions based at least in part on the row-wise representation.

In accordance with yet another aspect, an apparatus comprising at least one processor and at least one memory including computer program code is provided. In one embodiment, the at least one memory and the computer program code may be configured to, with the processor, cause the apparatus to: for each column value, generate a column-wise representation using an encoder sub-model of an attention-based encoder-decoder machine learning model, wherein: (a) the attention-based encoder-decoder machine learning model comprises the encoder sub-model, a plurality of vertical self-attention sub-models, and a plurality of decoder sub-models, (b) during a training iteration, the attention-based encoder-decoder machine learning model is updated based at least in part on an inferred column value for each training column value of a plurality of training column values of a training table row, (c) the plurality of training column values comprise a masked training column value of the training table row, and (d) during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model; generate the row-wise representation based at least in part on each column-wise representation; and perform one or more prediction-based actions based at least in part on the row-wise representation.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating an attention-based encoder-decoder machine learning model in accordance with some embodiments discussed herein.

FIGS. 5-6 provide operational examples of generating masked table rows in accordance with some embodiments discussed herein.

FIG. 7 provides an operational example of an attention-based encoder-decoder machine learning model in accordance with some embodiments discussed herein.

FIG. 8 provides an operational example of a vertical self-attention sub-model in accordance with some embodiments discussed herein.

FIG. 9 is a flowchart diagram of an example process for determining whether a table row pair is deemed linked/similar in accordance with some embodiments discussed herein.

FIG. 10 provides an operational example of generating a row-wise representation for a table row in accordance with some embodiments discussed herein.

FIG. 11 provides an operational example of a prediction output user interface that displays cross-row similarity measures for a set of table row pairs in accordance with some embodiments discussed herein.

FIG. 12 provides an operational example of a prediction output user interface that displays a similarity matrix visualization for a set of table rows in accordance with some embodiments discussed herein.

FIG. 13 provides an operational example of performing a set of data ingestion operations in accordance with some embodiments discussed herein.

FIG. 14 is a flowchart diagram of an example process for determining whether a particular column pair is deemed linked/similar in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNICAL IMPROVEMENTS

Various embodiments of the present invention provide techniques for improving computational efficiency of performing database integration operations. A database integration operation is any operation that seeks to resolve/merge/consolidate at least one row and/or at least one column of a first relational table with at least one row and/or at least one column of a second relational table. Examples of database integration operations include merging rows of two databases and/or merging columns of two databases.

For example, various embodiments of the present invention use cross-row similarity measures and/or cross-column similarity measures to construct a k-dimensional tree data object that enables performing data ingestion operations. In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

Accordingly, at least by disclosing using cross-row similarity measures and/or cross-column similarity measures to construct a k-dimensional tree data object that enables performing data ingestion operations, various embodiments of the present invention address technical challenges related to performing database integration operations and address the efficiency and reliability shortcomings of existing database integration solutions.

### II. DEFINITIONS

The term “masked column value” may refer to a data construct that is generated by replacing the initial column value for a particular column with a masked value. In some embodiments, generating a masked column value for a particular column value that is associated with a particular column is performed based at least in part on the column format type for the particular column. For example, if the particular column has a categorical column format type, the masked value may be a zero-hot encoding value (i.e., a value that is defined to have a one-hot encoding of zero, such as an all-zero value having a size of n, where n is the size of the one-hot encoding representations generated based at least in part on the column values for the particular column). As another example, if the particular column has a continuous column format type, the masked value may be a value having a designated extreme numeric value, such as zero, infinity, or a value that is deemed to be the upper bound and/or the lower bound of an allowed range of the particular column that has the continuous column format type. As yet another example, if the particular column has a sequential column format type, the masked value is generated by replacing each character of the corresponding column value with a designated replacement character, such as a designated replacement character that is not frequently used in natural language strings (e.g., the designated replacement character of ˜ or the designated replacement character of D.

The terms “masked table row” or “training table row” may both refer to a data construct that is configured to describe a table row that has at least one masked column value. In some embodiments, to generate a training table row, a computing entity: (i) selects (e.g., randomly samples) a particular table row of the table data object, (ii) selects (e.g., randomly selects) a designated column of the columns of the table data object to mask, and (iii) generates the training table row based at least in part on a masked table row that is generated by updating the particular row via replacing the column value of the particular table row that is associated with the designated column with a masked column value. In some embodiments, masked table rows having a masked column value for a designated column are used to determine cross-column similarity scores and/or cross-column linking determinations for the designated column with respect to other columns.

The term “attention-based encoder-decoder machine learning model” may refer to a data construct that is configured to describe parameters, hyper-parameters, and/or defined operations of a machine learning model that is configured to process a table row in order to generate an inferred column value for each column value of the table row. As further described above, in some embodiments, the attention-based encoder-decoder machine learning model comprises an encoder sub-model, a plurality of vertical self-attention sub-models, and a plurality of decoder sub-models; during a training iteration, the attention-based encoder-decoder machine learning model is updated based at least in part on an inferred column value for each training column value of a plurality of training column values of a training table row; the plurality of training column values comprise a masked training column value of the training table row; and during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model. In some embodiments, inputs to the attention-based encoder-decoder machine learning model comprise a vector that describes a numerical representation of each column value of an input table row, while outputs of the attention-based encoder-decoder machine learning model comprise a set of vectors each describing an inferred column value for an initial column value of the input table row.

The term “encoder sub-model” may refer to a data construct that is configured to describe parameters, hyper-parameters, and/or defined operations of a component of a machine learning model that is configured to generate a column-wise representation for each column value of an input table row. In some embodiments, the attention-based encoder-decoder machine learning model may comprise an encoder sub-model that is configured to generate a column representation for each column value that is provided to it. Therefore, the encoder sub-model may be a multi-headed encoder. In some embodiments, to generate a column representation for a particular column value of a particular column, the encoder sub-model is configured to process a column value numerical representation of the particular column value based at least in part on one or more parameters of the encoder sub-model in order to generate the column representation of the particular column value, where the column value numerical representation for the particular column value may be generated based at least in part on the column format type of the particular column. For example, in some embodiments, if the particular column has a categorical column format type, the column value numerical representation for the particular column value is generated based at least in part on a one-hot encoding representation of the particular column value. As another example, in some embodiments, if the particular column has a continuous column format type, the column value numerical representation for the particular column value is generated without making any changes to the column-wise representation. As yet another example, if the particular column has a sequential column format type, the column value numerical representation for the particular column value is generated based at least in part on an output of processing the particular column value using an embedding machine learning model that comprises a long short term memory (LSTM) sub-model (e.g., using an embedding machine learning model that includes an embedding layer followed by an LSTM unit, and based at least in part on the output of the final hidden state of a final time step of the LSTM unit). In some embodiments, inputs to the encoder sub-model comprise a vector that describes a numerical representation of each column value of an input table row, while outputs of the encoder sub-model comprise a set of vectors each describing the column-wise representation of a column value of an incoming table row.

The term “vertical self-attention sub-model” may refer to a data construct that is configured to describe parameters, hyper-parameters, and/or defined operations of a component of a machine learning model that is configured to process all of the column-wise representations for all of the column values of a table row in order to generate an attenuated representation for a column that is associated with the vertical self-attention sub-model. In some embodiments, the attention-based encoder-decoder machine learning model may comprise a set of vertical self-attention sub-models, where each vertical self-attention sub-model is associated with a corresponding column and is configured to process column-wise representations for all the columns of an input table row to generate an attenuated representation for the corresponding column that is associated with the vertical self-attention sub-model. Importantly, in at least some embodiments, the inputs to each vertical self-attention sub-model include all of the column-wise representations for all of the column values of the input table row, and not just the column-wise representation for the column value that is associated with the corresponding column for the vertical self-attention sub-model. In some embodiments, inputs to a vertical self-attention sub-model comprise a set of vectors each describing the column-wise representation of a column value of an incoming table row, while outputs of a vertical self-attention sub-model comprise an attenuated representation that may be a vector.

The term “decoder sub-model” may refer to a data construct that is configured to describe parameters, hyper-parameters, and/or defined operations of a component of a machine learning model that is configured to process the attenuated representation that is associated with a column value for a column that corresponds to the decoder sub-model in order to generate an inferred column value for the noted column value. In some embodiments, the attention-based encoder-decoder machine learning model may comprise a set of decoder sub-models, where each decoder sub-model is associated with a corresponding column and is configured to process the attenuated representation for the corresponding column to generate an inferred column value for the corresponding column. In some embodiments, if a column has a categorical column format type, then the decoder model for the column may comprise a fully connected neural network machine learning model, such as a fully connected neural network machine learning model with an output layer utilizing a softmax activation that may be trained using a categorical cross-entropy loss function. In some embodiments, if a column has a continuous column format type, then the decoder model for the column may comprise a fully connected neural network machine learning model, such a fully connected neural network machine learning model with an output layer having one output node that is trained using at least one of a Mean Absolute Error loss function and a Root Mean Square Error loss function. In some embodiments, if a column has a sequential column format type, then the decoder model for the column may comprise at least one of a gated recurrent unit machine learning model and a softmax activation layer, e.g., a combination of a gated recurrent unit machine learning model and an output layer utilizing softmax activation which may be trained using an average categorical cross-entropy loss function. In some embodiments, inputs to a decoder sub-model include an attenuated representation which may be a vector, while outputs of a decoder sub-model include an inferred column value which may be a vector or an atomic value. In some embodiments, the decoder sub-model is a classification machine learning model, and thus the inferred column value describes a class to which the corresponding column value is predicted to belong. In some of the noted embodiments, outputs of a decoder sub-model that is associated with a particular column having a particular column value in an input training row comprises a vector, where each vector value describes a predicted likelihood that the particular column value is associated with a corresponding class that is associated with the vector value.

The term “attenuation representation” may refer to a data construct that is configured to describe an output of a vertical self-attention sub-model for a particular column value of a corresponding column that is associated with the vertical self-attention sub-model. For example, in some embodiments, given a set of column values {c₁, . . . , cₙ} that are associated with the column-wise representations {cr₁, . . . , crₙ}, the vertical attention sub-model for a column value c_{d} may: (i) generate attention scores {as₁, . . . , asₙ} for the set of column values {c₁, . . . , cₙ} that describe how each column in the noted set relates to c_{d}; (ii) combine the attention scores {as₁, . . . , asₙ} into an attention score vector ASV; (iii) perform a normalization operation on ASV to generate a normalized attention score vector NASV; (iv) for each column value c₁ from the set of column values {c₁, . . . , cₙ}, combine the NASV with the column-wise representation crᵢ for cᵢ to generate a per-column attenuated representation caᵢ for cᵢ, and (v) combine all per-column attenuated representations into an attention representation for c_{d}. In some embodiments, an attention representation is a vector.

The term “attention score” may refer to a data construct that is configured to describe a computed/inferred relevance of a first table column value of an input table row for a first table column to a second table column value of the input table row for a second table column. In some embodiments, to generate the attenuated representation for a particular column value of a particular column that is associated with a vertical self-attention sub-model, the vertical attention sub-model generates an attention score for each column-wise representation that is provided as an input to the vertical self-attention sub-model, where the attention score for a given column-wise representation of a given column value of a given column may describe an inferred relationship strength for a column pair comprising the particular column and the given column. In some embodiments, the noted vertical self-attention sub-model may generate the attenuated representation for a particular column value based at least in part on each attention score generated by the vertical self-attention sub-model for a column-wise representation that is provided as an input to the vertical self-attention sub-model. For example, in some embodiments, the vertical self-attention sub-model may concatenate the attention scores into an attention score vector for the input table row, then apply a normalization operation (e.g., a softmax normalization operation) on the attention score vector to generate a normalized attention score vector for the input table row, then combine (e.g., multiply) the normalized attention score vector with each column-wise representation for a given column value to generate a per-column attenuated representation for the particular column value, and then combine each into the final attenuated representation for the particular column value. In some embodiments, an attention score is either an atomic value or a vector. In some embodiments, the attention score for a column value of a column having a continuous column type format is computed using the output of the equation AttentionScore(x)=w*tanh(x+b₁)+b₂, where x is the column-wise representation for the column value, and w, b₁, b₂ are trainable weights. In some embodiments, the attention score for a column value of a column having a sequential column type format or a categorical column format type is computed using the output of the equation AttentionScore(X)=V*tanh(W*X+B)+b, where X is the column-wise representation for the column value, and W, B, V, b are trainable weight matrices/vectors.

The term “column-wise representation” may refer to a data construct that is configured to describe a fixed-size representation of a column value of a table row. In some embodiments, the column-wise representation for a particular column value is generated based at least in part on the output of an encoder sub-model that is configured to process the column values for a table row that comprises the particular column value in order to generate the column-wise representations for column values of the table row. In some embodiments, to generate a column representation for a particular column value of a particular column, the encoder sub-model is configured to process a column value numerical representation of the particular column value based at least in part on one or more parameters of the encoder sub-model in order to generate the column representation of the particular column value, where the column value numerical representation for the particular column value may be generated based at least in part on the column format type of the particular column. For example, in some embodiments, if the particular column has a categorical column format type, the column value numerical representation for the particular column value is generated based at least in part on a one-hot encoding representation of the particular column value. As another example, in some embodiments, if the particular column has a continuous column format type, the column value numerical representation for the particular column value is generated without making any changes to the column-wise representation. As yet another example, if the particular column has a sequential column format type, the column value numerical representation for the particular column value is generated based at least in part on an output of processing the particular column value using an embedding machine learning model that comprises a long short term memory (LSTM) sub-model (e.g., using an embedding machine learning model that includes an embedding layer followed by an LSTM unit, and based at least in part on the output of the final hidden state of a final time step of the LSTM unit).

The term “row-wise representation” may refer to a data construct that is configured to describe a fixed-size representation of a table row. In some embodiments, a computing entity combines the column-wise representations for column values of each table row in order to generate the row-wise representation for the table row. In some embodiments, a computing entity concatenates the column-wise representations for column values of each table row in order to generate the row-wise representation for the table row. In some embodiments, a computing entity provides the column-wise representations for column values of each table row to a column-wise representation combination machine learning model and generates the row-wise representation for the table row based at least in part on the output of processing the noted column-wise representations by the column-wise representation combination machine learning model.

The term “cross-row similarity measure” may refer to a data construct that is configured to describe an inferred measure of similarity for a table row pair that is determined based at least in part on a row-wise representation of a first table row in the table row pair and a row-wise representation of a second table row in the table row pair. In some embodiments, a computing entity determines a cross-row similarity measure for the two table rows based at least in part on a distance/similarity measure for the row-wise representations of the two table rows. An example of a distance/similarity measure for two row-wise representations is a Euclidean distance measure or a distance/similarity measure that is generated based at least in part on output of processing of the row-wise representations of the two table rows by a distance/similarity determination machine learning model. In some embodiments, a computing entity performs one or more prediction-based actions based at least in part on the cross-row similarity measure. For example, in some embodiments, a computing entity determines, for the two table pairs, a cross-row linking determination about whether the two tables rows should be linked/deemed similar based at least in part on whether the cross-row similarity measure satisfies a cross-row similarity measure threshold. In some of the noted embodiments, the computing entity determines an affirmative cross-row linking determination for the two table rows describing that the two tables rows should be linked/deemed similar if the cross-row similarity measure satisfies (e.g., exceeds) the cross-row similarity measure threshold, and determines a negative cross-row linking determination for the two table rows describing that the two tables rows should not be linked/deemed similar if the cross-row similarity measure fails to satisfy (e.g., fails to exceed) the cross-row similarity measure threshold. In some embodiments, the computing entity performs one or more prediction-based actions based at least in part on the noted cross-row linking determination.

The term “cross-column similarity measure” may refer to a data construct that is configured to describe an inferred measure of similarity for a column pair. In some embodiments, to generate a cross-column similarity measure for a masked column and a second column, a computing entity provides each generated column-wise representation for a column value of a masked row table that is associated with a particular column to a vertical self-attention sub-model for the masked column to generate an attention score for the column pair comprising the first column and the particular column. In some embodiments, performing the noted operations during N iterations for N table rows and with respect to a set of C columns generates N*C attention scores that are generated by one vertical self-attention sub-model alone (i.e., the vertical self-attention sub-model for a defined column whose column values are also masked), including N attention scores for each column. In some of the noted embodiments, the N attention scores for a given column are combined (e.g., averaged) to generate the cross-column similarity measure for a table pair comprising the masked column and the given column.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

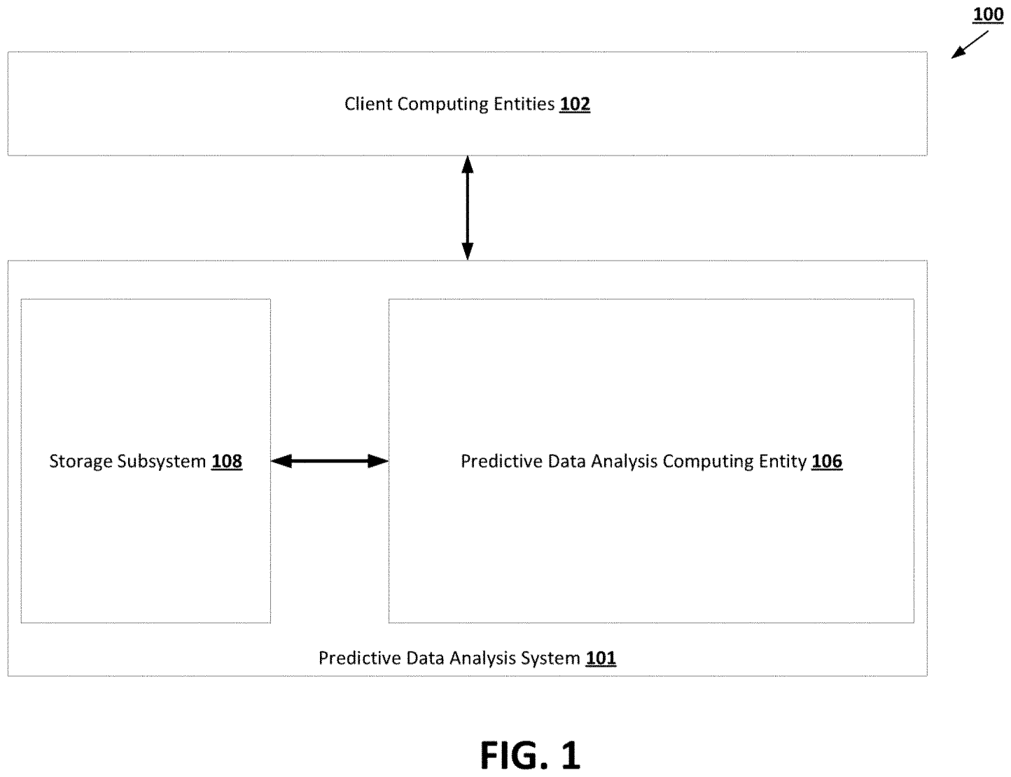

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions.

An example of a prediction-based action that can be performed using the predictive data analysis system 101 is a request for performing cross-row linking/similarity determinations for table row pairs. Another example of a prediction-based action that can be performed using the predictive data analysis system 101 is a request for performing cross-column linking/similarity determinations for table column pairs.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

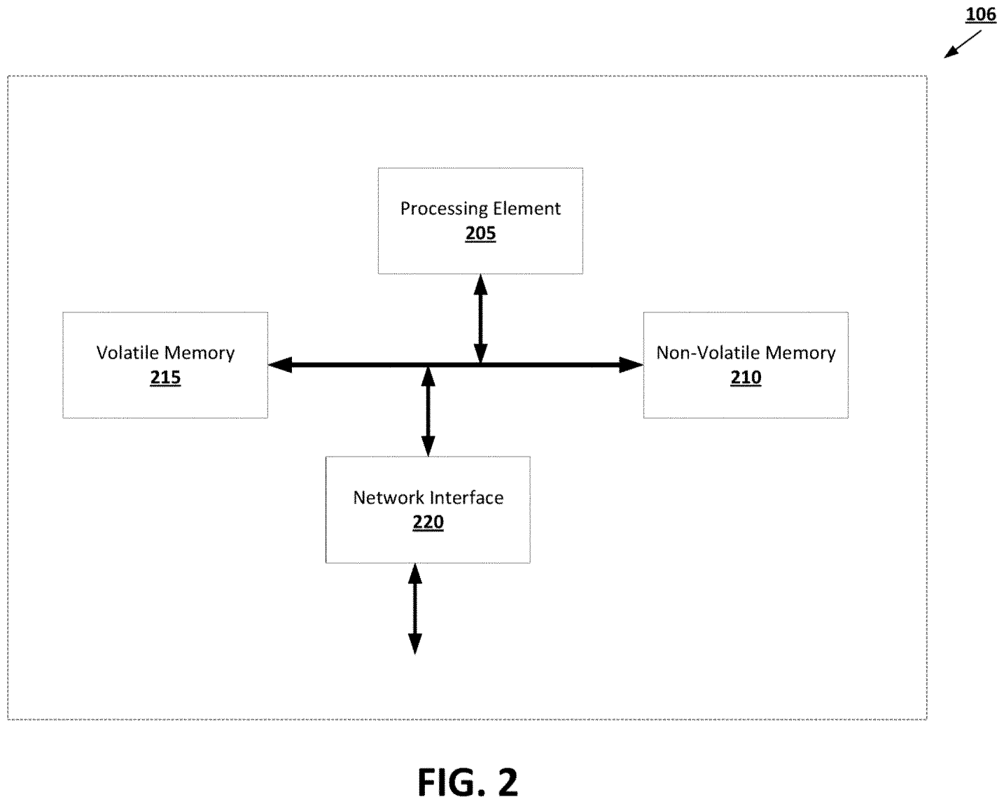

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

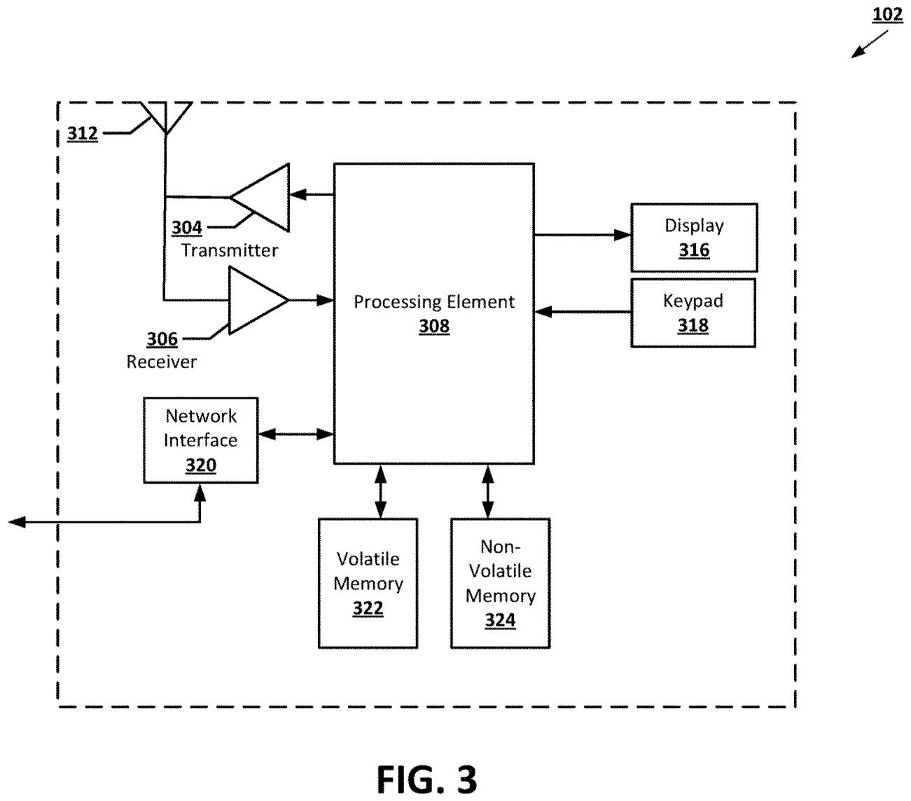

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

Provided below are exemplary techniques for generating an attention-based encoder-decoder machine learning model, for generating cross-row similarity measures for table row pairs using at least some of the outputs generated by at least some of the components of the attention-based encoder-decoder machine learning model, and for generating cross-column similarity measures for column pairs using at least some of the outputs generated by at least some of the components of the attention-based encoder-decoder machine learning model. However, while various embodiments of the present invention describe the model generation operations described herein, the cross-row similarity determination operations described herein, and the cross-column similarity determination operations described herein as being performed by the same single computing entity, a person of ordinary skill in the relevant technology will recognize that each of the noted sets of operations described herein can be performed by one or more computing entities that may be the same as or different from the one or more computing entities used to perform each of the other sets of operations described herein.

As described below, various embodiments of the present invention provide techniques for improving computational efficiency of performing database integration operations. For example, various embodiments of the present invention use cross-row similarity measures and/or cross-column similarity measures to construct a k-dimensional tree data object that enables performing data ingestion operations. In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

### Model Generation/Updating Operations

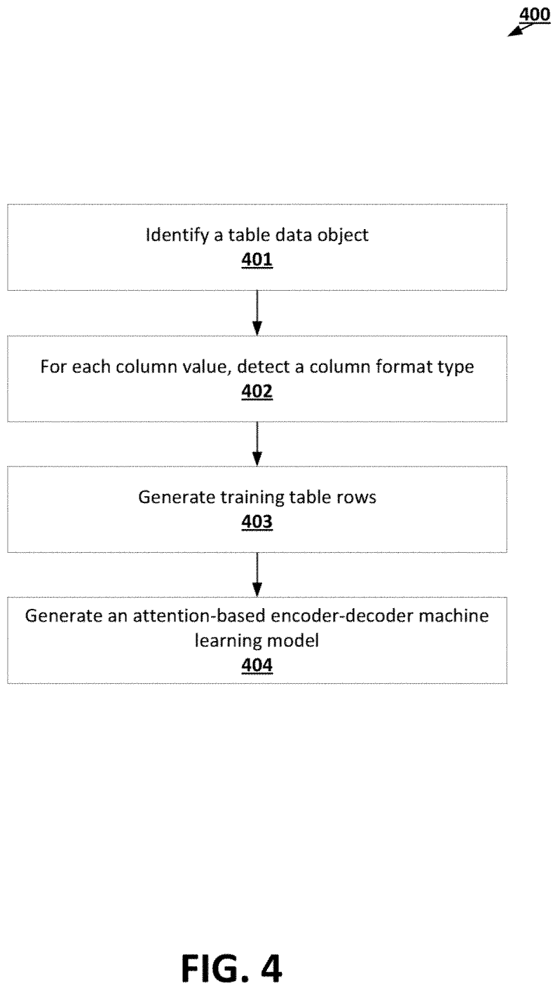

FIG. 4 is a flowchart diagram of an example process 400 for generating an attention-based encoder-decoder machine learning model. Once generated, the attention-based encoder-decoder machine learning model can generate outputs (e.g., intermediate outputs and/or final outputs) that can be used to determine whether two table rows and/or two table columns are deemed to be linked/similar.

The process 400 begins at step/operation 401 when the predictive data analysis computing entity 106 identifies a table data object having a plurality of table rows, where each table row has a set of column values each associated with a defined column of the table data object. In some embodiments, the table data object is generated by merging one or more relational tables (e.g., two or more relational tables having a common schema).

At step/operation 402, the predictive data analysis computing entity 106 detects, for each column, a column format type of the column that is associated with the column. The column format type may define an expected format of data patterns (e.g., character patterns) that may occur in column values having the corresponding column. For example, when a column is expected to have column values that describe a category of one or more categories (e.g., one or more gender categories, one or more state of residence categories, and/or the like), the column may be deemed to have a categorical column format type. As another example, when a column is expected to have column values that describe numerical values (e.g., an age value, an annual income value, and/or the like), the column may be deemed to have a continuous column format type. As yet another example, when a column is expected to have a sequence of alphanumeric characters that do not define a category of one or more categories or a numerical value (e.g., a name value, an address value, and/or the like), the column may be deemed to have a sequential column format type.

At step/operation 403, the predictive data analysis computing entity 106 generates one or more training table rows based at least in part on the table rows of the table data object. In some embodiments, to generate a training table row, the predictive data analysis computing entity 106: (i) selects (e.g., randomly samples) a particular table row of the table data object, (ii) selects (e.g., randomly selects) a designated column of the columns of the table data object to mask, and (iii) generates the training table row based at least in part on a masked table row that is generated by updating the particular row via replacing the column value of the particular table row that is associated with the designated column with a masked column value.

In some embodiments, generating a masked column value for a particular column value that is associated with a particular column is performed based at least in part on the column format type for the particular column. For example, if the particular column has a categorical column format type, the masked value may be a zero-hot encoding value (i.e., a value that is defined to have a one-hot encoding of zero, such as an all-zero value having a size n, where n is the size of the one-hot encoding representations generated based at least in part on the column values for the particular column). As another example, if the particular column has a continuous column format type, the masked value may be a value having a designated extreme numeric value, such as zero, infinity, or a value that is deemed to be the upper bound and/or the lower bound of an allowed range of the particular column that has the continuous column format type. As yet another example, if the particular column has a sequential column format type, the masked value is generated by replacing each character of the corresponding column value with a designated replacement character, such as a designated replacement character that is not frequently used in natural language strings (e.g., the designated replacement character of ˜ or the designated replacement character of |).

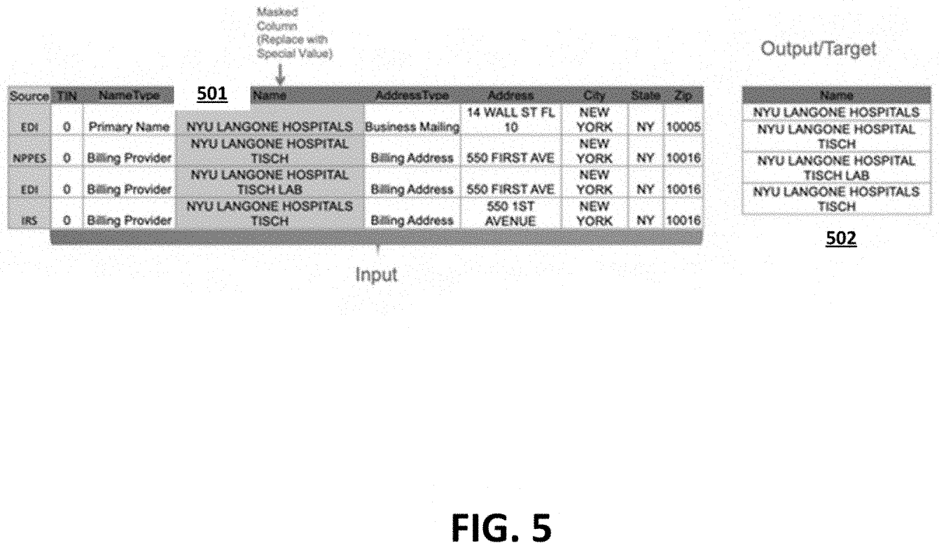

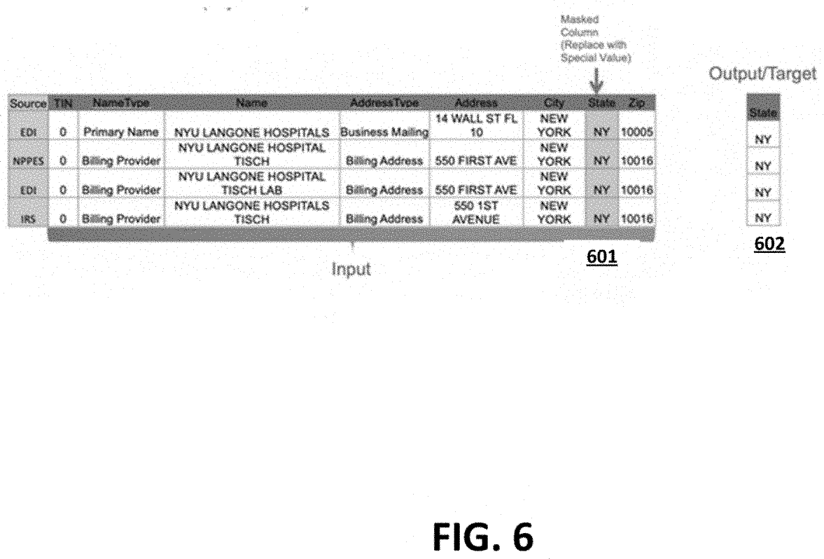

Operational examples of generating masked table rows are depicted in FIGS. 5-6. For example, as depicted in FIG. 5, the masked table rows can be generated by replacing the column values associated with the designated column 501 with a masked column value. As another example, as depicted in FIG. 6, the masked table rows can be generated by replacing the column values associated with the designated column 601 with a masked column value. As further depicted in FIGS. 5-6, each set of masking operations for a particular column generates a target column (i.e., the target column 502 in FIG. 5 and the target column 602 in FIG. 6) having the original column values of the designated column. As further described below, such target columns can be used in training the attention-based encoder-decoder machine learning model.

At step/operation 404, the predictive data analysis computing entity 106 generates the attention-based encoder-decoder machine learning model based at least in part on the one or more training table rows. In some embodiments, the attention-based encoder-decoder machine learning model is updated to optimize (e.g., to minimize) an error measure that is determined based at least in part on model outputs of the attention-based encoder-decoder machine learning model that are generated via processing the training table rows and table rows of the table data object that correspond to the noted training table rows. Accordingly, in at least some embodiments, the attention-based encoder-decoder machine learning model is trained using a training task characterized/evaluated by predicting original column values for masked column values of table rows of the table data object.

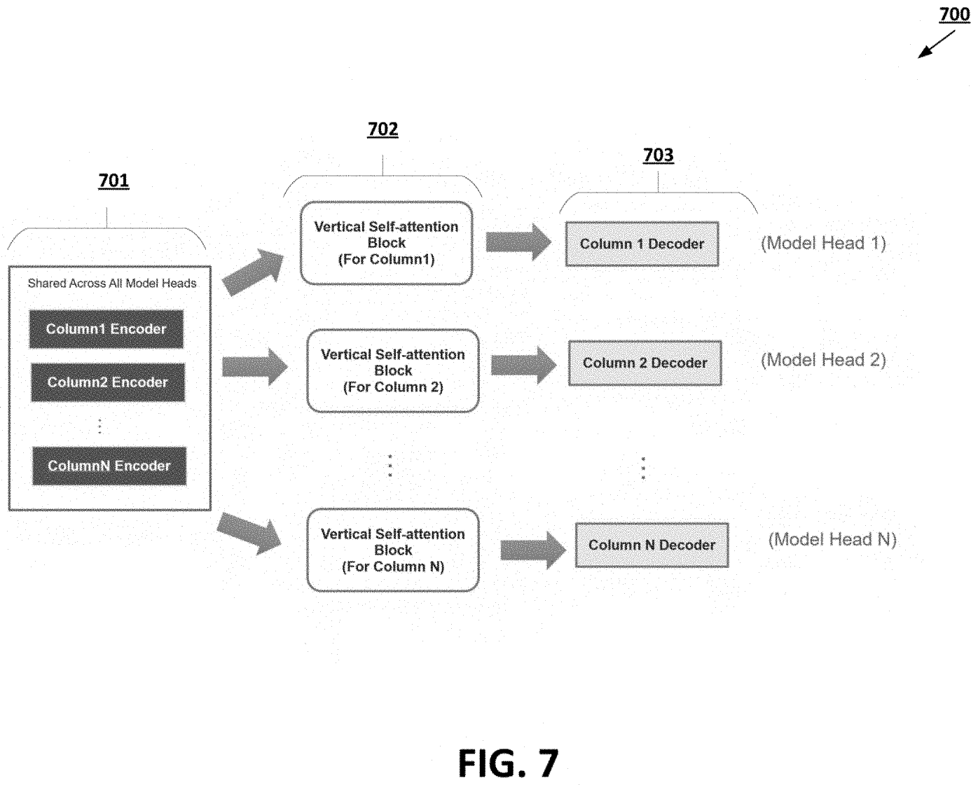

In some embodiments, the attention-based encoder-decoder machine learning model 700 has the architecture that is depicted in FIG. 7. As depicted in FIG. 7, the attention-based encoder-decoder machine learning model 700 comprises an encoder sub-model 701 that is configured to generate a column-wise representation for each column value of an input table row. As further depicted in FIG. 7, the attention-based encoder-decoder machine learning model 700 comprises a set of vertical self-attention sub-models 702, where each vertical self-attention sub-model is associated with a corresponding column and is configured to process column-wise representations for all the columns to generate an attenuated representation for the corresponding column that is associated with the vertical self-attention sub-model. As further depicted in FIG. 7, the attention-based encoder-decoder machine learning model 700 comprises a set of decoder sub-models 703, where each decoder sub-model is associated with a corresponding column and is configured to process the attenuated representation for the corresponding column to generate an inferred column value for the corresponding column. In some embodiments, the attention-based encoder-decoder machine learning model 700 is trained/updated to optimize (e.g., minimize) a measure of error that is determined based at least in part on deviations between the inferred column values generated by the set of decoder sub-models 703 and corresponding column values of the table data object. Accordingly, the attention-based encoder-decoder machine learning model 700 may be trained using a training task characterized/evaluated by predicting original column values for masked column values of table rows of the table data object.

Accordingly, as described above, the attention-based encoder-decoder machine learning model may comprise an encoder sub-model that is configured to generate a column representation for each column value that is provided to it. Therefore, the encoder sub-model may be a multi-headed encoder. In some embodiments, to generate a column representation for a particular column value of a particular column, the encoder sub-model is configured to process a column value numerical representation of the particular column value based at least in part on one or more parameters of the encoder sub-model in order to generate the column representation of the particular column value, where the column value numerical representation for the particular column value may be generated based at least in part on the column format type of the particular column. For example, in some embodiments, if the particular column has a categorical column format type, the column value numerical representation for the particular column value is generated based at least in part on a one-hot encoding representation of the particular column value. As another example, in some embodiments, if the particular column has a continuous column format type, the column value numerical representation for the particular column value is generated without making any changes to the column-wise representation. As yet another example, if the particular column has a sequential column format type, the column value numerical representation for the particular column value is generated based at least in part on an output of processing the particular column value using an embedding machine learning model that comprises a long short term memory (LSTM) sub-model (e.g., using an embedding machine learning model that includes an embedding layer followed by an LSTM unit, and based at least in part on the output of the final hidden state of a final time step of the LSTM unit).

Furthermore, the attention-based encoder-decoder machine learning model may comprise a set of vertical self-attention sub-models, where each vertical self-attention sub-model is associated with a corresponding column and is configured to process column-wise representations for all the columns of an input table row to generate an attenuated representation for the corresponding column that is associated with the vertical self-attention sub-model. Importantly, in at least some embodiments, the inputs to each vertical self-attention sub-model include all of the column-wise representations for all of the column values of the input table row, and not just the column-wise representation for the column value that is associated with the corresponding column for the vertical self-attention sub-model.

In some embodiments, to generate the attenuated representation for a particular column value of a particular column that is associated with a vertical self-attention sub-model, the vertical attention sub-model generates an attention score for each column-wise representation that is provided as an input to the vertical self-attention sub-model, where the attention score for a given column-wise representation of a given column value of a given column may describe an inferred relationship strength for a column pair comprising the particular column and the given column. In some embodiments, the noted vertical self-attention sub-model may generate the attenuated representation for a particular column value based at least in part on each attention score generated by the vertical self-attention sub-model for a column-wise representation that is provided as an input to the vertical self-attention sub-model. For example, in some embodiments, the vertical self-attention sub-model may concatenate the attention scores into an attention score vector for the input table row, then apply a normalization operation (e.g., a softmax normalization operation) on the attention score vector to generate a normalized attention score vector for the input table row, then combine (e.g., multiply) the normalized attention score vector with each column-wise representation for a given column value to generate a per-column attenuated representation for the particular column value, and then combine each into the final attenuated representation for the particular column value.

For example, in some embodiments, given a set of column values {c₁, . . . , cₙ} that are associated with the column-wise representations {cr₁, . . . , crₙ}, the vertical attention sub-model for a column value c_{d} may: (i) generate attention scores {as₁, . . . , asₙ} for the set of column values {c₁, . . . , cₙ} that describe how each column in the noted set relates to c_{d}; (ii) combine the attention scores {as₁, . . . , asₙ} into an attention score vector ASV; (iii) perform a normalization operation on ASV to generate a normalized attention score vector NASV; (iv) for each column value cᵢ from the set of column values {c₁, . . . , cₙ}, combine the NASV with the column-wise representation crᵢ for cᵢ to generate a per-column attenuated representation caᵢ for cᵢ, and (v) combine all per-column attenuated representations into an attention representation for c_{d}.

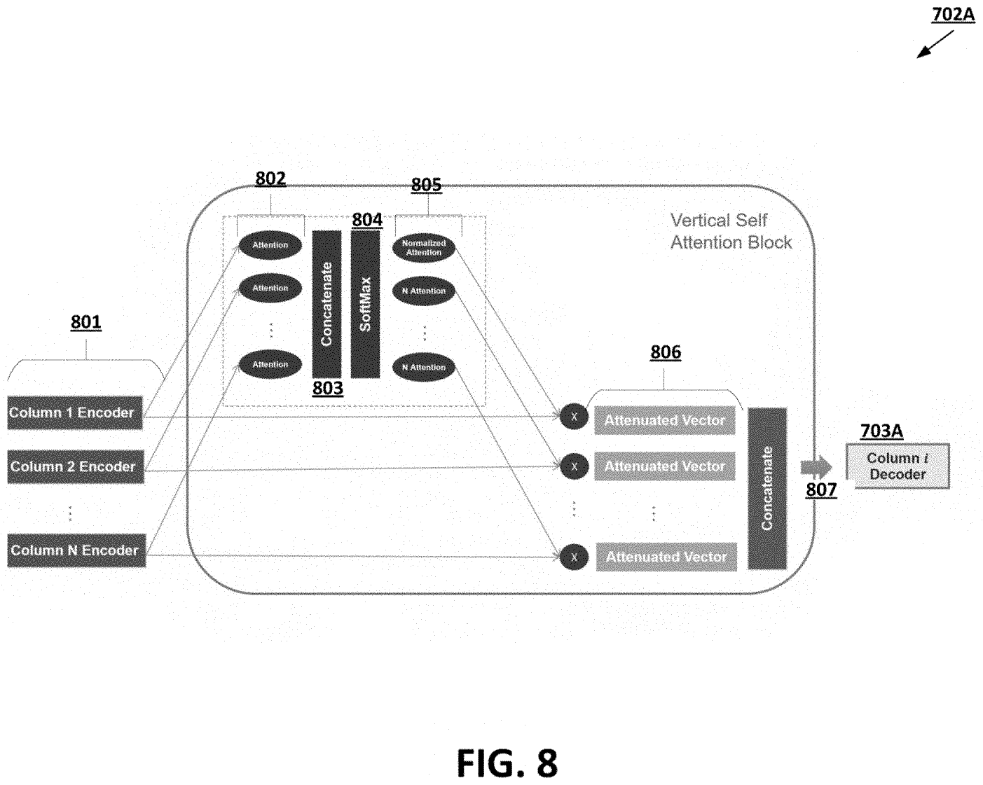

An operational example of a vertical self-attention sub-model 702A is depicted in FIG. 8. As depicted in FIG. 8, the vertical self-attention sub-model 702A is configured to process the column-wide representations 801 to generate the attention scores 802. The attention scores 802 are then concatenated using the concatenation layer 803 to generate an attention score vector that is then normalized using the softmax normalization layer 804 to generate the normalized attention score vector 805. The normalized attention score vector 805 is then combined with the column-wide representations 801 to generate per-column attenuated representations 806, which are then concatenated to generate the final attenuated representation 807 that is provided as an input for the decoder sub-model 703A that is associated with the corresponding column that is also associated with the vertical self-attention sub-model 702A.

In some embodiments, the attention score for a column value of a column having a continuous column type format is computed using the output of the equation AttentionScore(x)=w*tanh(x+b₁)+b₂, where xis the column-wise representation for the column value, and w, b₁, b₂ are trainable weights. In some embodiments, the attention score for a column value of a column having a sequential column type format or a categorical column format type is computed using the output of the equation AttentionScore(X)=V*tanh(W*X+B)+b, where X is the column-wise representation for the column value, and W, B, V, b are trainable weight matrices/vectors. In some embodiments, given an attention score vector having the values {AttensionScore_{col}_{₁}, AttensionScore_{col}_{₂}, . . . , AttensionScore_{col}_{ₙ}}, the corresponding normalized attention score vector is computed based at least in part on the output of the equation

$$Normalized Attention Vector = ( \frac{{e}^{{AttensionScore}_{{col}_{1}}}}{\sum {e}^{{AttensionScore}_{{col}_{i}}}} , \frac{{e}^{{AttensionScore}_{{col}_{2}}}}{\sum {e}^{{AttensionScore}_{{col}_{i}}}} , ⋯ , \frac{{e}^{{AttensionScore}_{{col}_{n}}}}{\sum {e}^{{AttensionScore}_{{col}_{i}}}} ) .$$

Moreover, the attention-based encoder-decoder machine learning model may comprise a set of decoder sub-models, where each decoder sub-model is associated with a corresponding column and is configured to process the attenuated representation for the corresponding column to generate an inferred column value for the corresponding column. In some embodiments, if a column has a categorical column format type, then the decoder model for the column may comprise a fully connected neural network machine learning model, such as a fully connected neural network machine learning model with an output layer utilizing a softmax activation that may be trained using a categorical cross-entropy loss function. In some embodiments, if a column has a continuous column format type, then the decoder model for the column may comprise a fully connected neural network machine learning model, such a fully connected neural network machine learning model with an output layer having one output node that is trained using at least one of a Mean Absolute Error loss function and a Root Mean Square Error loss function. In some embodiments, if a column has a sequential column format type, then the decoder model for the column may comprise at least one of a gated recurrent unit machine learning model and a softmax activation layer, e.g., a combination of a gated recurrent unit machine learning model and an output layer utilizing softmax activation which may be trained using an average categorical cross-entropy loss function.

By using the attention-based encoder-decoder machine learning models, various embodiments of the present invention provide techniques for improving computational efficiency of performing database integration operations. For example, various embodiments of the present invention use cross-row similarity measures and/or cross-column similarity measures to construct a k-dimensional tree data object that enables performing data ingestion operations. In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

### Cross-Row Linking/Similarity Determination Operations

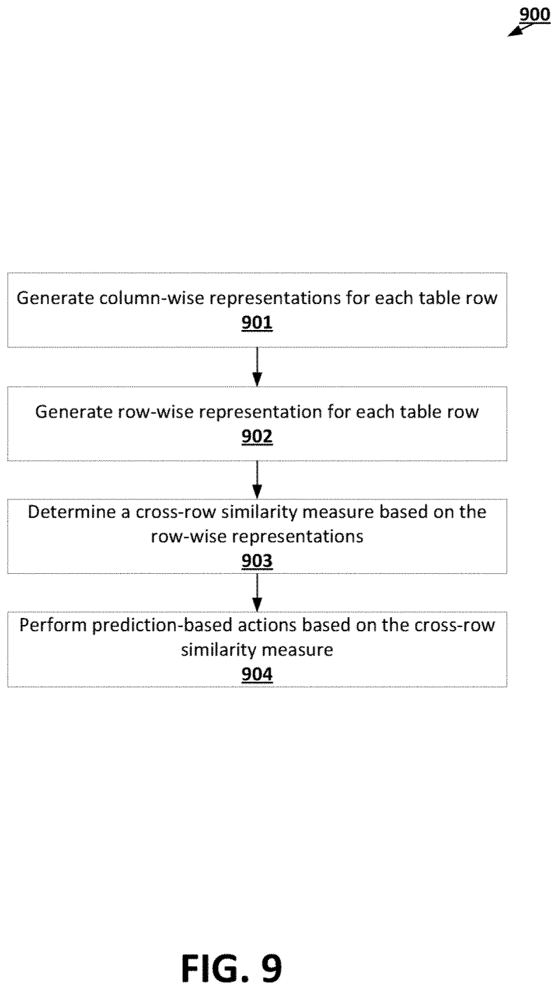

Once generated/trained/updated, the attention-based encoder-decoder machine learning model can be used in some embodiments to determine if pairs of table rows are deemed to be linked/similar. FIG. 9 is a flowchart diagram of an example process 900 for determining whether tow table rows comprising a first row and a second row are deemed linked/similar. The process 900 begins at step/operation 901 when the predictive data analysis computing entity 106 processes each of the two table rows using the encoder sub-model of the attention-based encoder-decoder machine learning model to generate, for each table row, a plurality of column-wise representations for the plurality of column values of the table row.

As described above, in some embodiments, the attention-based encoder-decoder machine learning model comprises an encoder sub-model, a plurality of vertical self-attention sub-models, and a plurality of decoder sub-models; during a training iteration, the attention-based encoder-decoder machine learning model is updated based at least in part on an inferred column value for each training column value of a plurality of training column values of a training table row; the plurality of training column values comprise a masked training column value of the training table row; and during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model.

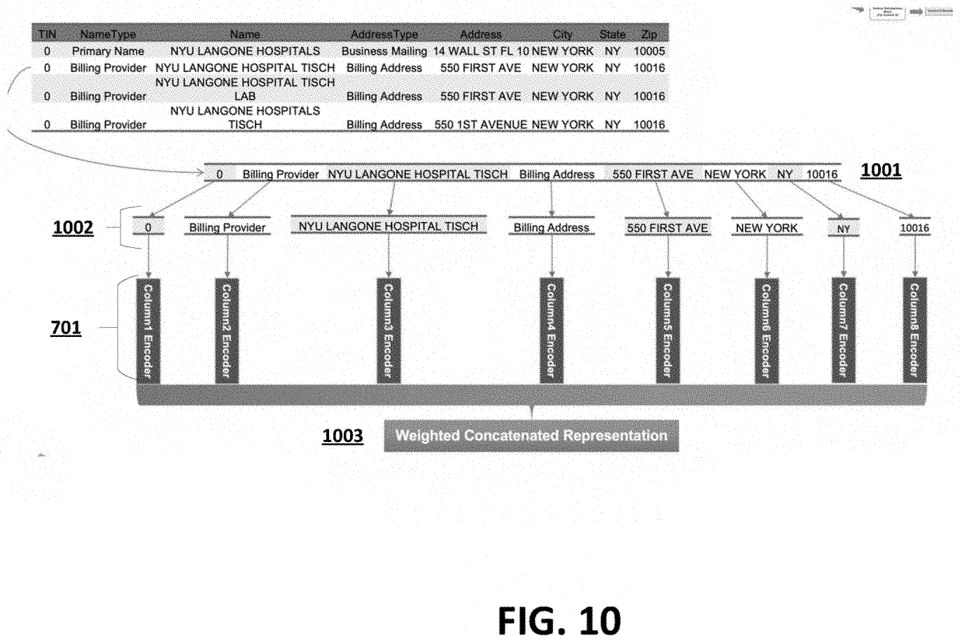

An operational example of performing step/operation 901 is depicted in FIG. 10. As depicted in FIG. 10, each column value of the column values 1002 of the table row 1001 is processed using a corresponding head of the encoder sub-model 701 to generate a column-wise representation that is the output of the corresponding head. As further depicted in FIG. 10, the column-wise representations for the column values 1002 of the table row 1001 are concatenated to generate a row-wise representation 1003 of the table row 1001, as further described below with respect to step/operation 902.

Returning to FIG. 9, at step/operation 902, the predictive data analysis computing entity 106 combines the column-wise representations for column values of each table row in order to generate the row-wise representation for the table row. In some embodiments, the predictive data analysis computing entity 106 concatenates the column-wise representations for column values of each table row in order to generate the row-wise representation for the table row. In some embodiments, the predictive data analysis computing entity 106 provides the column-wise representations for column values of each table row to a column-wise representation combination machine learning model and generates the row-wise representation for the table row based at least in part on the output of processing the noted column-wise representations by the column-wise representation combination machine learning model.

At step/operation 903, the predictive data analysis computing entity 106 determines a cross-row similarity measure for the two table rows based at least in part on a distance/similarity measure for the row-wise representations of the two table rows. An example of a distance/similarity measure for two row-wise representations is a Euclidean distance measure or a distance/similarity measure that is generated based at least in part on output of processing of the row-wise representations of the two table rows by a distance/similarity determination machine learning model.

At step/operation 904, the predictive data analysis computing entity 106 performs one or more prediction-based actions based at least in part on the cross-row similarity measure. For example, in some embodiments, the predictive data analysis computing entity 106 determines, for the two table pairs, a cross-row linking determination about whether the two tables rows should be linked/deemed similar based at least in part on whether the cross-row similarity measure satisfies a cross-row similarity measure threshold. In some of the noted embodiments, the predictive data analysis computing entity 106 determines an affirmative cross-row linking determination for the two table rows describing that the two tables rows should be linked/deemed similar if the cross-row similarity measure satisfies (e.g., exceeds) the cross-row similarity measure threshold, and determines a negative cross-row linking determination for the two table rows describing that the two tables rows should not be linked/deemed similar if the cross-row similarity measure fails to satisfy (e.g., fails to exceed) the cross-row similarity measure threshold. In some embodiments, the predictive data analysis computing entity 106 performs one or more prediction-based actions based at least in part on the noted cross-row linking determination.

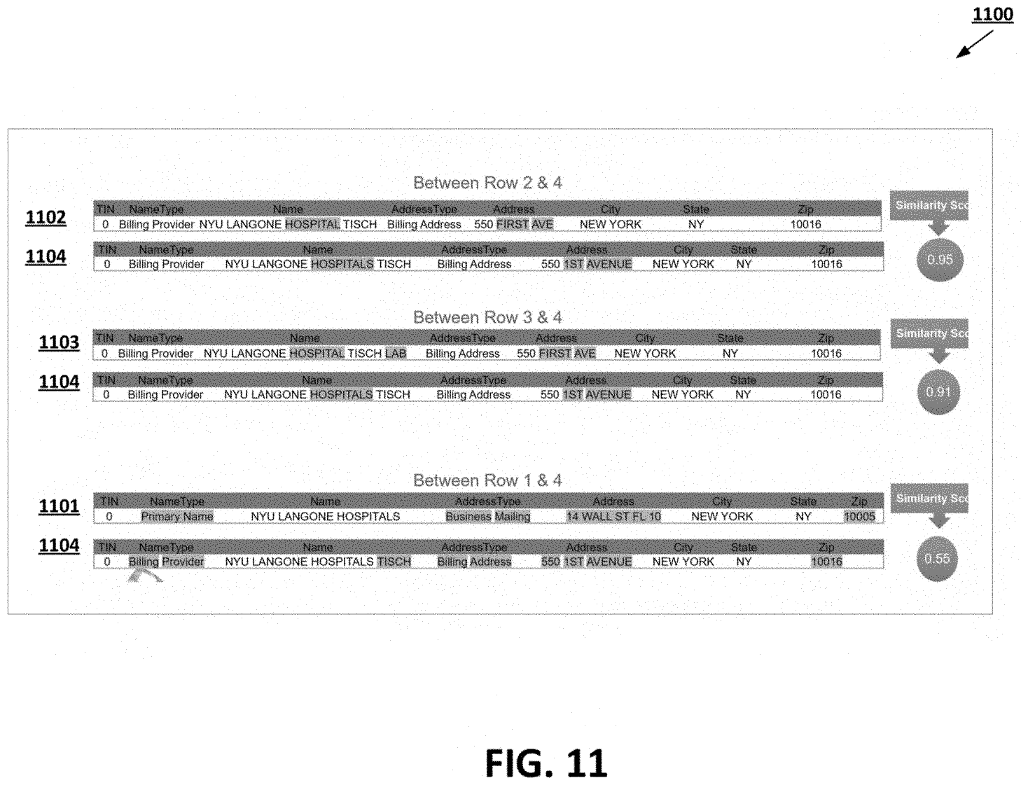

In some embodiments, the predictive data analysis computing entity 106 generates user interface data for a prediction output user interface that describes, for each selected table row pair, the cross-row similarity measure for the table row pair. An operational example of such a prediction output user interface 1100 is depicted in FIG. 11. As depicted in FIG. 11, the prediction output user interface 1100 describes that the table row pair comprising the table row 1102 and the table row 1104 is associated with the cross-row similarity measure of 0.95, the table row pair comprising the table row 1103 and the table row 1104 is associated with the cross-row similarity measure of 0.91, and the table row pair comprising the table row 1101 and the table row 1104 is associated with the cross-row similarity measure of 0.55. Once generated, the user interface data for the prediction output user interface can be used to display the prediction output user interface by the predictive data analysis computing entity 106 and/or can be transmitted to a client computing entity 102 that can process the user interface data to generate and present the prediction output user interface to an end-user of the client computing entity 102.

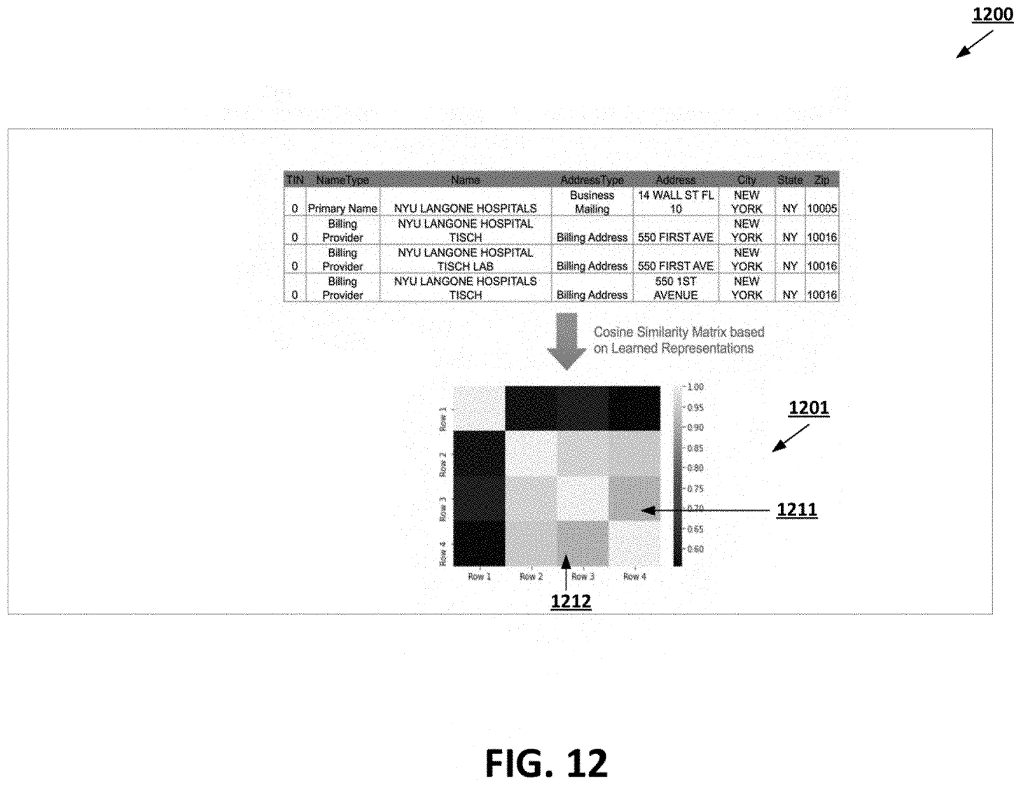

In some embodiments, given a set of n table rows, the cross-row similarity measure and/or the cross-row linking determination for each of the n * n table row pairs that can result from the set of n table rows can be described using a similarity matrix visualization having a set of similarity measure visualization regions that is each associated with a table row pair, where the coloring scheme (e.g., the coloring intensity) of each similarity measure visualization region describes a relative measure of the cross-row similarity measure for the table row pair that is associated with the noted similarity measure visualization region. As operational example of a prediction output user interface 1200 that describes such a similarity matrix visualization 1201 is depicted in FIG. 12.

As depicted in FIG. 12, the similarity matrix visualization 1201 is associated with sixteen similarity matrix visualization regions because, in this example, n=4. Each similarity matrix visualization region is associated with a table row pair, with one table row being defined by each dimension of the similarity matrix visualization region. For example, the similarity matrix visualization region 1211 is associated with table row Row3 as defined by the vertical dimension of the similarity matrix visualization 1201 and with table row Row4 as defined by the horizontal dimension of the similarity matrix visualization 1201. Moreover, as further depicted in FIG. 12, the coloring scheme of the similarity matrix visualization region 1211 denotes that the table row pair Row3-Row4 has a higher similarity matrix visualization region 1211 than the table row pairs for other neighboring similarity matrix visualization regions, except for the table row pair that is associated with the similarity matrix visualization region 1212, which is also the table row pair Row3-Row4.

As indicated by similarity matrix visualizations described above, cross-row similarity measures and/or cross-row linking determinations for a set of table row pairs can be combined to generate/display predictive inferences about internal duplication ratio of a set of table rows (e.g., a set of table rows of a particular relational table) or to generate/display predictive inferences about similarities across two or more relational tables and/or two or more table data objects. The noted predictive inferences can then be used to perform database consolidation operations and/or database integration operations. For example, in some embodiments, a system may merge/consolidate those table rows deemed to be linked/similar across a relational table. As another example, in some embodiments, a system may delete those table rows that are deemed to be lined/similar to a preserved table rows across a relational table. As yet another example, in some embodiments, a system may merge an incoming table having a set of incoming table rows into an existing table having a set of existing table rows in the following manner: (i) for each incoming table row, determining whether the set of existing table rows include an existing table row that has an affirmative cross-row linking determination with respect to the incoming table, (ii) in response to determining that an incoming table row is associated with an existing table row that has an affirmative cross-row linking determination with respect to the incoming table, augmenting data of the incoming table row into the existing table row and deleting the incoming table row, (iii) in response to determining that an incoming table row is associated with an existing table row that has a negative cross-row linking determination with respect to the incoming table, adding the incoming table row as a new row of the existing relational table and deleting the incoming table row.

In some embodiments, at a setup (e.g., right after training of the attention-based encoder-decoder machine learning model), a proposed system processes a table data object using the attention-based encoder-decoder machine learning model to generate a row-wise representation for each table row of the table data object, generates a cross-row linking determination for each table row pair of the table data object based at least in part on the generated row-wise representations of the table row pair, generates a k-dimensional tree data object that includes a node for each table row and connects two nodes for a table row pair if the table row pair is associated with an affirmative cross-row linking determination and fails to connect two nodes for a table row pair if the table row pair is associated with a negative cross-row linking determination, and then stores the k-dimensional tree data object. In some embodiments, the k-dimensional tree data object can now be queried to perform table row ingestion operations for an incoming table row, for example by detecting whether the k-dimensional tree data object includes an existing node for an existing table row that has an affirmative cross-row linking determination with respect to the incoming table row, and if so adding a new node for the incoming table row that has all of the edge associations of the noted existing node.

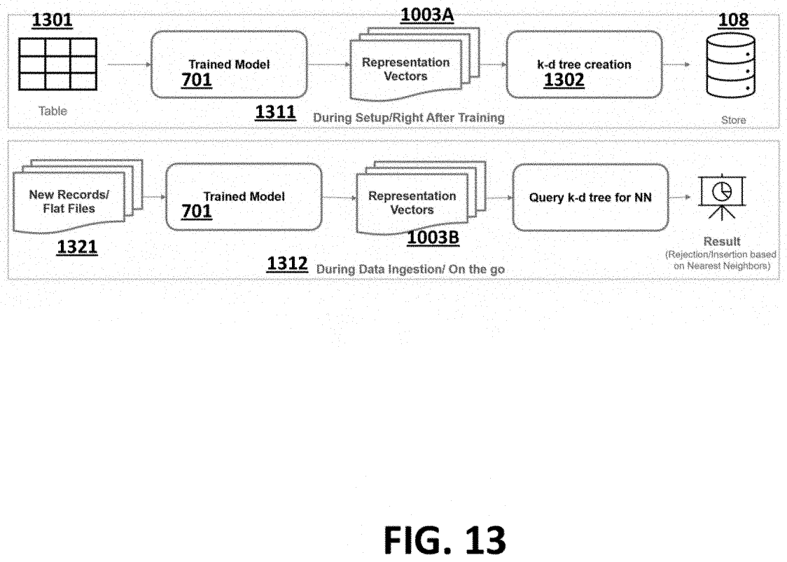

An operational example of performing data ingestion operations for incoming table rows is depicted in FIG. 13. As depicted in FIG. 13, during a setup phase 1311, table rows of the table data object 1301 are processed using the encoder sub-model 701 to generate row-wise representations 1003A, which can then be used to generate the k-dimensional tree data object 1302 that is then stored on the storage subsystem 108. As further depicted in FIG. 13, during a data ingestion phase 1312, incoming table rows 1321 are processed using the encoder sub-model 701 to generate row-wise representations 1003B. Thereafter, the k-dimensional tree data object 1302 is queried to determine whether each incoming table row is rejected or ingested based at least in part on whether the incoming table row is deemed linked/similar to a table row that is mapped to the k-dimensional tree data object 1302.

In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

By using cross-row linking/similarity determination operations described herein, various embodiments of the present invention provide techniques for improving computational efficiency of performing database integration operations. For example, various embodiments of the present invention use cross-row similarity measures and/or cross-column similarity measures to construct a k-dimensional tree data object that enables performing data ingestion operations. In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

### Cross-Column Linking/Similarity Determination Operations

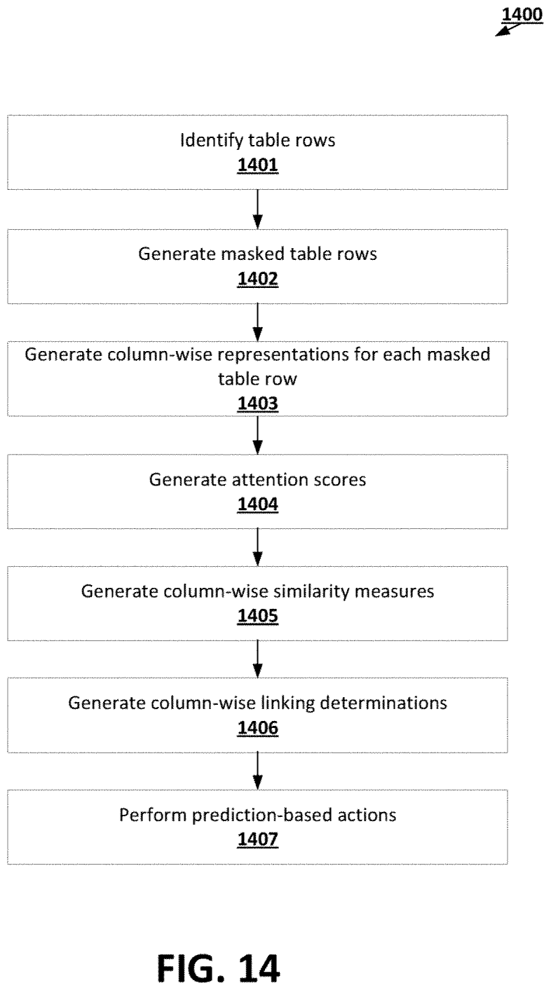

Once generated/trained/updated, the attention-based encoder-decoder machine learning model can alternatively or additionally be used in some embodiments to determine if pairs of columns of a table data object are deemed to be linked/similar. FIG. 14 is a flowchart diagram of an example process 1400 for determining whether a column pair comprising a first column and a second column are linked/similar. The process 1400 begins at step/operation 1401 when the predictive data analysis computing entity 106 identifies one or more table rows, such as a set of N sampled table rows having an schema that includes the first column and the second column.

At step/operation 1402, the predictive data analysis computing entity 106 generates one or more masked table rows based at least in part on the one or more table rows. In some embodiments, to generate each masked table row, the predictive data analysis computing entity 106 replaces the column value of a table row of the N table rows that is associated with the first column with a masked column value.

In some embodiments, generating a masked column value for a particular column value that is associated with a particular column is performed based at least in part on the column format type for the particular column. For example, if the particular column has a categorical column format type, the masked value may be a zero-hot encoding value (i.e., a value that is defined to have a one-hot encoding of zero, such as an all-zero value having a size n, where n is the size of the one-hot encoding representations generated based at least in part on the column values for the particular column). As another example, if the particular column has a continuous column format type, the masked value may be a value having a designated extreme numeric value, such as zero, infinity, or a value that is deemed to be the upper bound and/or the lower bound of an allowed range of the particular column that has the continuous column format type. As yet another example, if the particular column has a sequential column format type, the masked value is generated by replacing each character of the corresponding column value with a designated replacement character, such as a designated replacement character that is not frequently used in natural language strings (e.g., the designated replacement character of ˜ or the designated replacement character of |).

At step/operation 1403, the predictive data analysis computing entity 106 provides each masked table row to the encoder sub-model of the attention-based encoder-decoder machine learning model to generate a column-wise representation for the column values of the masked table row. In some embodiments, step/operations 1403-1404 are performed in N iterates, where during each iteration one masked table row of the N masked table rows is provided as an input to components of the attention-based encoder-decoder machine learning model.

As described above, the attention-based encoder-decoder machine learning model may comprise an encoder sub-model that is configured to generate a column representation for each column value that is provided to it. Therefore, the encoder sub-model is a multi-headed encoder. In some embodiments, to generate a column representation for a particular column value of a particular column, the encoder sub-model is configured to process a column value numerical representation of the particular column value based at least in part on one or more parameters of the encoder sub-model in order to generate the column representation of the particular column value, where the column value numerical representation for the particular column value may be generated based at least in part on the column format type of the particular column. For example, in some embodiments, if the particular column has a categorical column format type, the column value numerical representation for the particular column value is generated based at least in part on a one-hot encoding representation of the particular column value. As another example, in some embodiments, if the particular column has a continuous column format type, the column value numerical representation for the particular column value is generated without making any changes to the column-wise representation. As yet another example, if the particular column has a sequential column format type, the column value numerical representation for the particular column value is generated based at least in part on an output of processing the particular column value using an embedding machine learning model that comprises a long short term memory (LSTM) sub-model (e.g., using an embedding machine learning model that includes an embedding layer followed by an LSTM unit, and based at least in part on the output of the final hidden state of a final time step of the LSTM unit).

At step/operation 1404, the predictive data analysis computing entity 106 provides each generated column-wise representation for a column value of a masked row table that is associated with a particular column to the vertical self-attention sub-model for the first column to generate an attention score for the column pair comprising the first column and the particular column. In some embodiments, performing step/operation 1404 during N iterations for a set of C columns generates N*C attention scores that are generated by one vertical self-attention sub-model alone (i.e., the vertical self-attention sub-model for a defined first column whose column values are also masked), including N attention scores for each column.

At step/operation 1405, the predictive data analysis computing entity 106 determines, for each column pair comprising the first column and a corresponding column of the schema of the one or more table rows, a cross-column similarity measure based at least in part on the output of combining each attention score that is associated with the corresponding column. As described above, step/operation 1404 may generate N attention scores for each column, where all of the N attention scores are generated by one vertical self-attention sub-model alone (i.e., the vertical self-attention sub-model for a defined first column whose column values are also masked). In some of the noted embodiments, the N attention scores for a given column are combined (e.g., averaged) to generate the cross-column similarity measure for a table pair comprising the first column and the given column.

At step/operation 1406, the predictive data analysis computing entity 106 determines, for each column pair comprising the first column and a corresponding column of the schema of the one or more table rows, a cross-column linking determination based at least in part on the cross-column similarity measure for the column pair. In some embodiments, a column pair is determined to have an affirmative cross-column linking determination indicating that the column pair are linked/deemed similar if the cross-column similarity measure for the column pair satisfies (e.g., exceeds) a cross-column similarity measure threshold. In some embodiments, a column pair is determined to have a negative cross-column linking determination indicating that the column pair are not linked/deemed similar if the cross-column similarity measure for the column pair fails to satisfy (e.g., fails to exceed) a cross-column similarity measure threshold.

At step/operation 1407, the predictive data analysis computing entity 106 performs one or more prediction-based actions based at least in part on each cross-column linking determination and/or each cross-column similarity measure. In some embodiments, the predictive data analysis computing entity 106 generates user interface data for a prediction output user interface that describes, for each selected column pair, the cross-row similarity measure for the column pair. In some embodiments, given a set of m columns, the cross-column similarity measure and/or the cross-column similarity measure for each of the m * m column pairs that can result from the set of m columns can be described using a similarity matrix visualization having a set of similarity measure visualization regions that is each associated with a column pair, where the coloring scheme (e.g., the coloring intensity) of each similarity measure visualization region describes a relative measure of the cross-column similarity measure for the column pair that is associated with the noted similarity measure visualization region.

As indicated by similarity matrix visualizations described above, cross-column similarity measures and/or cross-column linking determinations for a set of column pairs can be combined to generate/display predictive inferences about internal duplication ratio of a set of columns (e.g., a set of columns of a particular relational table) or to generate/display predictive inferences about similarities across two or more relational tables and/or two or more table data objects. The noted predictive inferences can then be used to perform database consolidation operations and/or database integration operations. For example, in some embodiments, a system may merge/consolidate those columns deemed to be linked/similar across a relational table. As another example, in some embodiments, a system may delete those columns that are deemed to be lined/similar to a preserved columns across a relational table. As yet another example, in some embodiments, a system may merge an incoming table having a set of incoming columns into an existing table having a set of existing columns in the following manner: (i) for each incoming column, determining whether the set of existing columns include an existing column that has an affirmative cross-column linking determination with respect to the incoming table, (ii) in response to determining that an incoming column is associated with an existing column that has an affirmative cross-column linking determination with respect to the incoming table, augmenting data of the incoming column into the existing column and deleting the incoming column, (iii) in response to determining that an incoming column is associated with an existing column that has a negative cross-column linking determination with respect to the incoming table, adding the incoming column as a new column of the existing relational table and deleting the incoming column.

By using cross-column linking/similarity determination operations described herein, various embodiments of the present invention provide techniques for improving computational efficiency of performing database integration operations. For example, various embodiments of the present invention use cross-row similarity measures and/or cross-column similarity measures to construct a k-dimensional tree data object that enables performing data ingestion operations. In some embodiments, using a the k-dimensional tree data object to perform data ingestion operations is storage-wise efficient as it has a linear storage complexity with respect to the number of table rows mapped to the k-dimensional tree data object. Moreover, using a the k-dimensional tree data object to perform data ingestion operations is computationally efficient as searching the k-dimensional tree data object can be performed with logarithmic computational complexity with respect to the number of table rows that are currently mapped to the k-dimensional tree data object, mapping a new table row into the k-dimensional tree data object can be performed with logarithmic computational complexity with respect to the number of table rows that are being newly mapped to the k-dimensional tree data object, and deleting an existing table row from the table rows mapped to the k-dimensional tree data object can be performed with logarithmic computational complexity with respect to the number of existing table rows that are being removed from the table rows mapped to the k-dimensional tree data object. However, while various embodiments of the present invention describe performing data ingestion operations using k-dimensional tree data objects, a person of ordinary skill in the relevant technology will recognize that other data structures may be used to describe cross-row similarity measures and/or cross-row linking determinations across a set of defined table row pairs.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a row-wise representation of a table row having a plurality of column values that are associated with a plurality of columns, the computer-implemented method comprising:
for each column value, generating, using a processor and an encoder sub-model of an attention-based encoder-decoder machine learning model, a column-wise representation, wherein:
the attention-based encoder-decoder machine learning model comprises the encoder sub-model, a plurality of vertical self-attention sub-models, and a plurality of decoder sub-models,
during a training iteration, the attention-based encoder-decoder machine learning model is updated based at least in part on an inferred column value for each training column value of a plurality of training column values of a training table row,
the plurality of training column values comprise a masked training column value of the training table row, and
during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model;
generating, using the processor, the row-wise representation based at least in part on each column-wise representation; and
performing, using the processor, one or more prediction-based actions based at least in part on the row-wise representation.

2. The computer-implemented method of claim 1, wherein:
the encoder sub-model is configured to determine each column-wise representation for a particular column value of a particular column based at least in part on a column value numerical representation of the particular column value, and
the column value numerical representation for the particular column value is generated based at least in part on a column format type of the particular column.

3. The computer-implemented method of claim 1, wherein generating the column value numerical representation for the particular column value comprises:
in response to determining that the particular column has a categorical column format type, generating the column value numerical representation based at least in part on a one-hot encoding representation of the particular column value.

4. The computer-implemented method of claim 1, wherein generating the column value numerical representation for the particular column comprises:
in response to determining that the particular column has a sequential column format type, generating the column value numerical representation based at least in part on an output of processing the particular column value using an embedding machine learning model that comprises a long short term memory (LSTM) sub-model.

5. The computer-implemented method of claim 1, wherein generating the masked training column value for the training table row comprises:
identifying a designated column of the plurality of columns for the training table row;
in response to determining that an initial column value of the training table row for the designated column has a categorical column format type, generating the masked training column value based at least in part on a zero-hot encoding value.

6. The computer-implemented method of claim 1, wherein generating the masked training column value for the training table row comprises:
identifying a designated column of the plurality of columns for the training table row;
in response to determining that an initial column value of the training table row for the designated column has a continuous column format type, generating the masked training column value based at least in part on a designated extreme numeric value.

7. The computer-implemented method of claim 1, wherein generating the masked training column value for the training table row comprises:
identifying a designated column of the plurality of columns for the training table row;
in response to determining that an initial column value of the training table row for the designated column has a sequential column format type, generating the masked training column value by replacing each character of the initial column value with a defined replacement character.

8. The computer-implemented method of claim 1, further comprising:
generating, using the processor, a masked table row by replacing a designated column value of the table row that is associated with a designated column of the plurality of columns with a masked column value;
determining, using the processor and the vertical self-attention sub-model that is associated with the designated column and based at least in part on the masked table row, an attention score for each column pair comprising a first column of the plurality of columns and the designated column value; and
determining, using the processor and based at least in part on each attention score, a cross-column linking determination for each column pair based at least in part on the attention score for the column pair.

9. The computer-implemented method of claim 1, wherein performing the one or more prediction-based actions based at least in part on the row-wise representation comprises:
identifying a second row-wise representation of a second table row;
generating, based at least in part on the row-wise representation and the second row-wise representation, a cross-row linking determination for the table row and the second table row; and
performing the one or more prediction-based actions based at least in part on the cross-row linking determination.

10. The computer-implemented method of claim 9, wherein:
the table row and the second table row are selected from N table rows, and performing the one or more prediction-based actions comprises:
for each table row pair that is selected from the selected from N table rows, determining whether to map the table row pair to a k-dimensional tree data object based at least in part on the cross-row linking determination for the k-dimensional tree data object, and
enabling access to a stored version of the k-dimensional tree data object, wherein the k-dimensional tree data object can be used to perform one or more data ingestion operations.

11. An apparatus for generating a row-wise representation of a table row having a plurality of column values that are associated with a plurality of columns, the apparatus comprising at least one processor and at least one memory including program code, the at least one memory and the program code configured to, with the processor, cause the apparatus to at least:
for each column value, generate a column-wise representation using an encoder sub-model of an attention-based encoder-decoder machine learning model, wherein:
the attention-based encoder-decoder machine learning model comprises the encoder sub-model, a plurality of vertical self-attention sub-models, and a plurality of decoder sub-models,
during a training iteration, the attention-based encoder-decoder machine learning model is updated based at least in part on an inferred column value for each training column value of a plurality of training column values of a training table row,
the plurality of training column values comprise a masked training column value of the training table row, and
during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model;
generate the row-wise representation based at least in part on each column-wise representation; and
perform one or more prediction-based actions based at least in part on the row-wise representation.

12. The apparatus of claim 11, wherein:
the encoder sub-model is configured to determine each column-wise representation for a particular column value of a particular column based at least in part on a column value numerical representation of the particular column value, and
the column value numerical representation for the particular column value is generated based at least in part on a column format type of the particular column.

13. The apparatus of claim 11, wherein generating the column value numerical representation for the particular column value comprises:
in response to determining that the particular column has a categorical column format type, generating the column value numerical representation based at least in part on a one-hot encoding representation of the particular column value.

14. The apparatus of claim 11, wherein generating the column value numerical representation for the particular column comprises:
in response to determining that the particular column has a sequential column format type, generating the column value numerical representation based at least in part on an output of processing the particular column value using an embedding machine learning model that comprises a long short term memory (LSTM) sub-model.

15. The apparatus of claim 11, wherein generating the masked training column value for the training table row comprises:
identifying a designated column of the plurality of columns for the training table row;
in response to determining that an initial column value of the training table row for the designated column has a categorical column format type, generating the masked training column value based at least in part on a zero-hot encoding value.

16. The apparatus of claim 11, wherein generating the masked training column value for the training table row comprises:
identifying a designated column of the plurality of columns for the training table row;
in response to determining that an initial column value of the training table row for the designated column has a continuous column format type, generating the masked training column value based at least in part on a designated extreme numeric value.

17. The apparatus of claim 11, wherein generating the masked training column value for the training table row comprises:
identifying a designated column of the plurality of columns for the training table row;
in response to determining that an initial column value of the training table row for the designated column has a sequential column format type, generating the masked training column value by replacing each character of the initial column value with a defined replacement character.

18. The apparatus of claim 11, wherein the at least one memory and the program code are further configured to, with the processor, cause the apparatus to at least:
generate a masked table row by replacing a designated column value of the table row that is associated with a designated column of the plurality of columns with a masked column value;
determine, using the vertical self-attention sub-model that is associated with the designated column and based at least in part on the masked table row, an attention score for each column pair comprising a first column of the plurality of columns and the designated column value; and
determine, based at least in part on each attention score, a cross-column linking determination for each column pair based at least in part on the attention score for the column pair.

19. The apparatus of claim 11, wherein performing the one or more prediction-based actions based at least in part on the row-wise representation comprises:
identifying a second row-wise representation of a second table row;
generating, based at least in part on the row-wise representation and the second row-wise representation, a cross-row linking determination for the table row and the second table row; and
performing the one or more prediction-based actions based at least in part on the cross-row linking determination.

20. A computer program product for generating a row-wise representation of a table row having a plurality of column values that are associated with a plurality of columns, the computer program product comprising at least one non-transitory computer-readable storage medium having computer-readable program code portions stored therein, the computer-readable program code portions configured to:
for each column value, generate a column-wise representation using an encoder sub-model of an attention-based encoder-decoder machine learning model, wherein:
the attention-based encoder-decoder machine learning model comprises the encoder sub-model, a plurality of vertical self-attention sub-models, and a plurality of decoder sub-models,
during a training iteration, the attention-based encoder-decoder machine learning model is updated based at least in part on an inferred column value for each training column value of a plurality of training column values of a training table row,
the plurality of training column values comprise a masked training column value of the training table row, and
during the training iteration: (i) the encoder sub-model is configured to determine an inferred column-wise representation for each training column value, (ii) each vertical self-attention sub-model is configured to determine an attenuated representation for a corresponding column that is associated with the vertical self-attention sub-model based at least in part on each inferred column-wise representation, and (iii) each decoder sub-model is configured to determine an inferred column value for the corresponding column that is associated with the decoder sub-model based at least in part on the attenuated representation for the corresponding column that is associated with the decoder sub-model,
generate the row-wise representation based at least in part on each column-wise representation; and
perform one or more prediction-based actions based at least in part on the row-wise representation.
